(19) United States
(12) Patent Application Publication
(10) Pub. No.: US 2026/0168505 A1
(43) Pub. Date: Jun. 18, 2026

(54) BLOWER

(71) Applicant: JIANGSU DONGCHENG M&E TOOLS CO., LTD., Nantong (CN)

(72) Inventor: Chengli LIU, Nantong (CN)

(21) Appl. No.: 18/996,150

(22) PCT Filed: Jun. 28, 2024
(86) PCT No.: PCT/CN2024/102293

§ 371 Date: Jan. 17, 2025

(30) Foreign Application Priority Data
Aug. 30, 2023 (CN) 202311107705.9

(51) Int. Cl. F04D 25/08; F04D 19/00; F04D 29/54

(52) U.S. Cl. CPC F04D 25/08; F04D 19/002; F04D 29/541

(57) ABSTRACT

The present disclosure relates to a blower. The blower comprises a housing extending in an axial direction, a battery pack detachably connected to the housing, a power assembly at least partially accommodated in the housing, and an air duct assembly connected to the housing, wherein the housing comprises a connecting portion arranged at an axial front end and connected to the air duct assembly, a mounting portion arranged at an axial rear end and connected to the battery pack, and a body portion arranged between the connecting portion and the mounting portion, the power assembly comprises a motor and a fan driven to rotate by the motor, and the fan rotates to generate airflow passing through the interior of the air duct assembly; the body portion is provided with an air inlet located at an axial rear end, and the air inlet is approximately located on two opposite sides of the mounting portion in a lateral direction perpendicular to the axial direction, so as to improve the efficiency of air inlet and cool the battery pack at the same time.

### TECHNICAL FIELD

The present disclosure relates to a blower, in particular to a blower that improves the efficiency of air inlet and dissipates heat from a battery pack.

### BACKGROUND

As a commonly used gardening tool, the blower includes a housing, an air duct connected to the housing, a culvert accommodated in the housing, a motor arranged in the culvert, and a fan driven to rotate by the motor, and during use, the fan rotates to generate a negative pressure in the housing, and the outside air enters into the housing from an air inlet of the housing and then is blown out from an air outlet of the air duct, thereby blowing fallen leaves or dust to a specific position. At present, in order to prevent debris from entering the housing due to the negative pressure generated by the fan, an air inlet hood with a grille is usually detachably mounted at the air inlet, thereby increasing the number of parts and leading to an increase in the assembly process and an increase in the material costs and assembly costs.

With rapid development of the market, requirements for the performance of blowers are getting higher and higher, and the requirements of users mainly focus on blowing power, wind speed, endurance time, etc. In order to improve these performances, the area of the air inlet generally needs to be increased, and a motor of a high rotation speed or a large-capacity battery pack is used. At present, some blowers available on the market have begun to use motors of a high rotation speed or large-capacity battery packs, however, the motors of a high rotation speed or large-capacity battery packs will generate a large amount of heat during operation of the blower, thereby leading to difficulties in heat dissipation of the motor and the battery pack.

In view of this, an improved blower actually needs to be provided to overcome the defects of the prior art.

### SUMMARY

In view of deficiencies of the prior art, the present disclosure aims at providing a blower that can improve the efficiency of air inlet and dissipates heat from a battery pack.

The present disclosure may adopt the following technical solutions to solve problems in the prior art: a blower includes a housing extending in an axial direction, a battery pack detachably connected to the housing, a power assembly at least partially accommodated in the housing, and an air duct assembly connected to the housing, wherein the housing includes a connecting portion arranged at a front end of the housing in the axial direction and connected to the air duct assembly, a mounting portion arranged at a rear end of the housing in the axial direction and connected to the battery pack, and a body portion arranged between the connecting portion and the mounting portion, the power assembly includes a motor at least partially arranged in the body portion and a fan driven to rotate by the motor, and the fan rotates to generate airflow passing through the interior of the air duct assembly; the body portion is provided with an air inlet located at a rear end of the body portion in the axial direction, and the air inlet is approximately located on two opposite sides of the mounting portion in a lateral direction perpendicular to the axial direction.

A further improved solution is as follows: the airflow enters the housing from the air inlet, and in the flow direction of the airflow, the battery pack is at least partially exposed to the airflow upstream of the air inlet.

A further improved solution is as follows: the body portion includes a receiving wall connected to the mounting portion, the air inlet is approximately parallel to or aligned with the receiving wall in the lateral direction, and the air inlet is approximately located on two sides of the receiving wall in the lateral direction.

A further improved solution is as follows: the housing includes a handle portion connecting the body portion to the mounting portion, the receiving wall is approximately a closed structure in an axial direction and includes a first side wall facing the handle portion and a second side wall facing the battery pack, and the first side wall and the second side wall are respectively located on two opposite sides of the mounting portion in a vertical direction perpendicular to the axial direction and the lateral direction.

A further improved solution is as follows: the air inlet includes a first air inlet region located on two sides of the first side wall in the lateral direction and a second air inlet region located on two sides of the second side wall in the lateral direction, and an included angle formed between the flow direction of the airflow entering from the first air inlet region and the flow direction of the airflow entering from the second air inlet region is less than or equal to 90°.

A further improved solution is as follows: the receiving wall includes a third side wall connected to the second side wall, the first side wall and the third side wall are located on two sides of the second side wall in a vertical direction, respectively, the air inlet includes a third air inlet region located on two sides of the third side wall in the lateral direction, and an included angle formed between the flow direction of the airflow entering from the third air inlet region and the flow direction of the airflow entering from the second air inlet region is less than or equal to 90°.

A further improved solution is as follows: the blower includes a number of guiding portions arranged at intervals at the air inlet, the air inlet includes at least two air inlet regions open towards different directions, an included angle formed between the extension directions of the guiding portions of two adjacent air inlet regions is less than or equal to 90°, and the guiding portion and the body portion are integrated.

A further improved solution is as follows: the body portion is approximately a closed structure in a circumferential direction perpendicular to the axial direction.

In the present disclosure, the following technical solution may also be adopted to solve problems in the prior art: a blower includes a housing extending in an axial direction, a battery pack detachably connected to the housing, a power assembly at least partially accommodated in the housing, and an air duct assembly connected to the housing, wherein the housing includes a connecting portion connected to the air duct assembly, a body portion connected to a rear side of the connecting portion in the axial direction, and a mounting portion configured to connect the battery pack and connected to the body portion, the power assembly includes a motor at least partially arranged in the body portion and a fan driven to rotate by the motor, and the fan rotates to generate airflow passing through the interior of the air duct assembly; wherein the body portion is provided with an air inlet located at a rear end in the axial direction, and the air inlet is approximately located on two opposite sides of the mounting portion in a lateral direction perpendicular to the axial direction

A further improved solution is as follows: the sum of the circumferential radians occupied by the air inlet in a circumferential direction perpendicular to the axial direction is greater than or equal to 90°.

Compared with the prior art, the present disclosure has the following beneficial effects: an air inlet connected to external fluid is arranged at a rear end of the body portion in the axial direction, and the air inlet is located at two sides of the mounting portion for mounting the battery pack in a lateral direction, such that at least part of the airflow flows through the surface of the battery pack before entering the air inlet, so as to dissipate heat from the battery pack during operation of the blower; in addition, an air inlet is arranged in at least three regions at a rear end of the body portion in the axial direction, and the included angle formed between the flow directions of airflow of two adjacent air inlet regions is less than or equal to 90°, so as to reduce collision loss when the airflow of different air inlet regions converges, and further increase the area of air inlet and improve the efficiency of air inlet.

### BRIEF DESCRIPTION OF THE DRAWINGS

FIG. 1 shows a schematic diagram of the entire blower of a preferred embodiment of the present disclosure.

FIG. 2 shows a front view of the blower shown in FIG. 1 with a battery pack and a blowpipe removed.

FIG. 3 shows a bottom view of the blower shown in FIG. 2 with the battery pack removed.

FIG. 4 shows a right view of the blower shown in FIG. 2 with the battery pack removed.

FIG. 5 shows a sectional view of the blower shown in FIG. 2 with the battery pack removed.

FIG. 6 shows a partially disassembled view of the blower of another embodiment of the present disclosure.

FIG. 7 shows a structural schematic diagram of the blower shown in FIG. 6 after a guiding hood is removed.

FIG. 8 shows a sectional view of the blower shown in FIG. 6.

Reference numerals in the FIGS.:

| | |
|---|---|
| blower: 100 | housing: 10, 10′ |
| connecting portion: 11, 11′ | body portion: 12, 12′ |
| air inlet: 121, 121′ | receiving wall: 122, 122′ |
| extension wall: 123 | first expanding segment: 124 |
| second expanding segment: 125 | arc segment: 126 |
| first side wall: 127, 127′ | second side wall: 128, 128′ |
| third side wall: 129, 129′ | mounting portion: 13, 13′ |
| guiding track: 131 | handle portion: 14, 14′ |
| supporting portion: 15 | front portion: 151 |
| rear portion: 152 | intermediate portion: 153 |
| intermediate groove: 154 | notch: 155 |
| guiding portion: 16 | fixing portion: 17′ |
| annular groove: 171′ | power assembly: 20, 20′ |
| motor: 21, 21′ | drive shaft: 211, 211′ |
| fan: 22, 22′ | hub: 221 |
| fan blade: 222 | motor casing: 23 |
| guiding cone: 24 | air duct assembly: 30 |
| blowpipe: 31 | air outlet: 311 |
| air inlet pipe: 32, 32′ | shell: 321, 321′ |
| static guide vane: 322 | guiding portion: 323, 323′ |
| clamping hook: 324′ | base portion: 325′ |
| hook portion: 326′ | reinforcing portion: 327′ |
| guiding hood: 33′ | axial opening: 331′ |
| axial outlet: 332′ | hood portion: 333′ |
| positioning portion: 334′ | clamping groove: 335′ |
| concave portion: 336′ | first inclined guiding portion: 337′ |
| second inclined guiding portion: 338′ | ejection structure: 40 |
| rotating rod: 41 | elastic member: 42 |
| protruding block: 43 | |

### DETAILED DESCRIPTION OF THE EMBODIMENTS

The present disclosure will be described in detail below in combination with accompanying drawings and embodiments.

The terms used in the present disclosure are merely for the purpose of describing particular embodiments, rather than limiting the present disclosure. For example, the following terms indicating orientation or positional relationship such as “upper”, “lower”, “front” and “rear” are merely based on the orientation or positional relationship shown in the accompanying drawings, and are merely used for facilitating description of the present disclosure and simplifying the description, rather than indicating or implying that the devices/elements referred to must have a particular orientation or be constructed and operated in a particular orientation, and therefore cannot be construed as a limitation of the present disclosure.

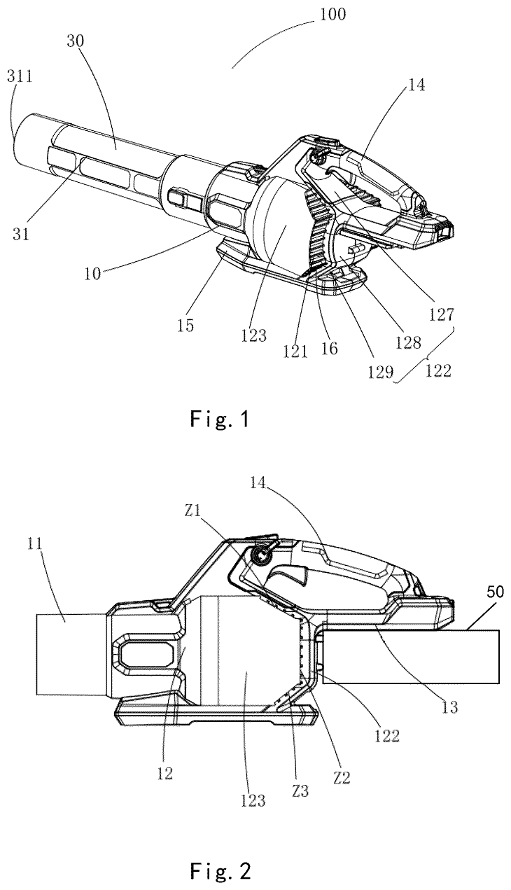

Referring to FIGS. 1 to 5, the present disclosure relates to a blower 100. The blower 100 includes a housing 10 extending in an axial direction, a battery pack 50 detachably connected to the housing 10, a power assembly 20 at least partially accommodated in the housing 10 and an air duct assembly 30 detachably connected to the housing 10.

The housing 10 includes a connecting portion 11 connected to the air duct assembly 30 at a front end of the housing in the axial direction, a body portion 12 connected to a rear side of the connecting portion 11 in the axial direction, and a mounting portion 13 configured to connect the battery pack 50 and connected to the body portion 12, and the battery pack 50 is detachably connected to the mounting portion 13 in the axial direction. A width of the body portion 12 is greater than a width of the mounting portion 13 in a lateral direction perpendicular to the axial direction. In the axial direction, the connecting portion 11, the body portion 12 and the mounting portion 13 are arranged in sequence. The housing 10 includes a handle portion 14 connected at one end to the top of the body portion 12 and connected at the other end to the top of the mounting portion 13, and the handle portion 14 extends upwards and is spaced apart from the body portion 12 and the mounting portion 13 so as to form a gripping space therebetween for a user to hold.

The air duct assembly 30 includes a blowpipe 31 detachably connected to the connecting portion 11 and an air inlet pipe 32 at least partially accommodated in the housing 10, and the blowpipe 31 and the air inlet pipe 32 together form a channel for the passage of airflow. The air inlet pipe 32 includes a shell 321 fixed to the interior of the housing 10, and the power assembly 20 is at least partially accommodated in the shell 321. The power assembly 20 includes a motor 21 having a drive shaft 211 and a fan 22 driven to rotate by the motor 21, and the fan 22 rotates to generate airflow passing through the channel of the air duct assembly 30.

The power assembly 20 further includes a motor casing 23 at least partially accommodating the motor 21 and a guiding cone 24 connected to the front end of the motor casing 23 in the axial direction, and the motor 21 is accommodated in the internal space formed by the motor casing 23 and the guiding cone 24. The guiding cone 24 is formed to be a conical structure which is gradually inclined towards the drive shaft 211 from back to front. The drive shaft 211 extends axially rearwards out of the motor casing 23, and the fan 22 includes a hub 221 fixed to the drive shaft 211 which extends out of the motor casing 23, and a plurality of fan blades 222 extending into the channel from the periphery of the hub 221. An annular airflow channel is formed approximately between the motor casing 23 and the shell 321 of the air inlet pipe 32, the blower 100 further includes static guide vanes 322 connected between the shell 321 and the motor casing 23, and the static guide vanes 322 are arranged downstream of the fan blades 222 in the flow direction of airflow.

Referring to FIGS. 1 and 2, the housing 10 includes a supporting portion 15 arranged at the bottom of the body portion 12 to support the entire machine, and in the axial direction, the supporting portion 15 extends for a length approximately covering the entire axial length of the body portion 12. In the vertical direction perpendicular to the axial direction, the handle portion 14 and the supporting portion 15 are arranged on two opposite sides of the body portion 12, respectively. The mounting portion 13 extends approximately in the axial direction such that the battery pack 50 is axially slidably connected to provide power to the power assembly 20.

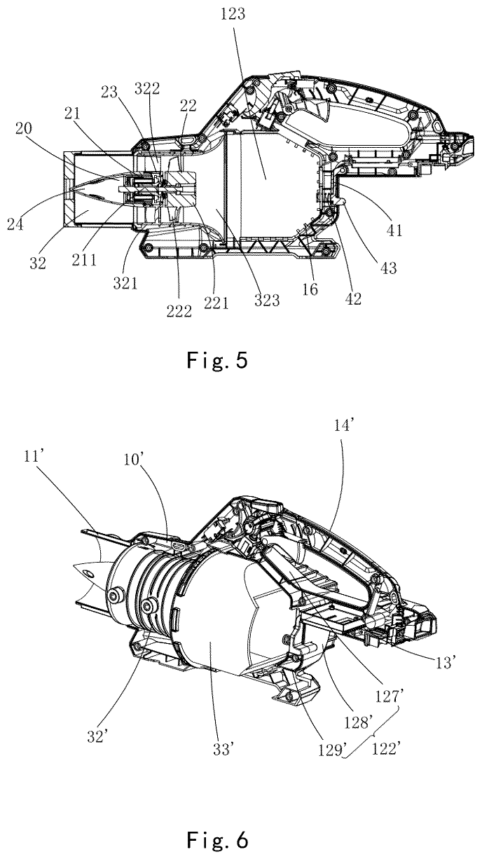

An air inlet 121 is arranged at a rear end of the body portion 12 in the axial direction, and the blowpipe 31 includes an air outlet 311 located at the front end in the axial direction. As shown in combination with FIG. 5, when the blower 100 operates, the drive shaft 211 rotates to drive the fan blade 222 to rotate and generate a negative pressure in the channel, and the outside air enters into the body portion 12 from the air inlet 121 and then enters the channel of the air inlet pipe 32 under the action of an air pressure, and then the outside air is accelerated by the rotating fan blade 222 and is combed by the static guide vane 322 to become an airflow approximately parallel to the axial direction, and then is guided by the guiding cone 24 to enter into the blowpipe 31 and is blown out via the air outlet 311. In the lateral direction, the blowpipe 31, the air inlet pipe 32 and the mounting portion 13 are arranged approximately aligned, such that the airflow does not change the flow direction approximately after entering the housing 10, and the airflow flows at least partially through the battery pack 50 to cool the battery pack 50 before entering the housing 10.

The mounting portion 13 is connected to the rear end of the body portion 12 in the axial direction, and the body portion 12 includes a receiving wall 122 located at the rear end in the axial direction and an extension wall 123 connecting the above connecting portion 11 to the air inlet 121. In a lateral direction perpendicular to the axial direction, the size of the extension wall 123 is greater than the size of the receiving wall 122, and the air inlet 121 is arranged in a protruding region of the extension wall 123 which protrudes laterally from the receiving wall 122. In the lateral direction perpendicular to the axial direction, the air inlets 121 are located approximately on two sides of the receiving wall 122 in the lateral direction and the air inlets 121 are approximately aligned with the receiving wall 122 in the axial direction.

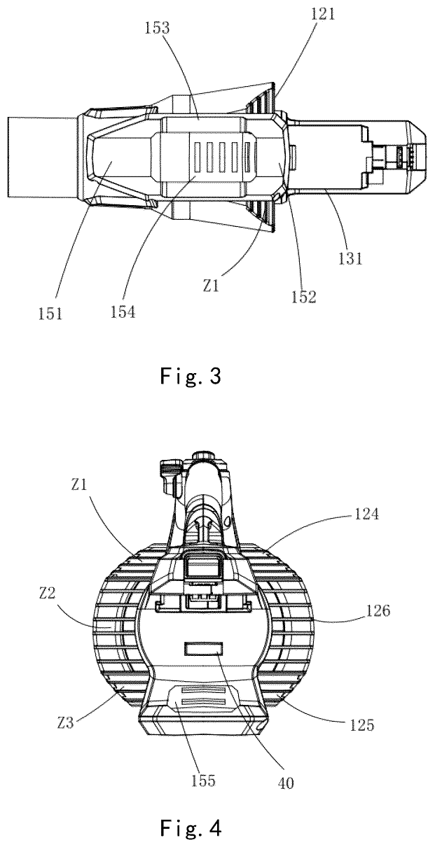

As shown in combination with FIGS. 3 and 4, the air inlet 121 is arranged between the mounting portion 13 and the connecting portion 11 in the axial direction and is arranged approximately on two sides of the mounting portion 13 in the lateral direction; a projection of the air inlet 121 in the vertical direction at least partially coincides with a projection of the handle portion 14 in the vertical direction, and a projection of the air inlet 121 in the axial direction at least partially coincides with a projection of the battery pack 50 in the axial direction. Through such a setting, the battery pack 50 is at least partially exposed within the airflow upstream of the air inlet 121 in the flow direction of airflow, that is, the airflow at least partially flows over and around the surface of the battery pack 50 before passing through the air inlet 121, thereby cooling the battery pack 50 during operation of the blower 100.

Referring to FIGS. 1 and 4, the extension wall 123 is formed to extend outwards from two sides of the body portion 12 in the lateral direction, and includes a first expanding segment 124 extending laterally outwards from the top of the body portion 12, a second expanding segment 125 extending laterally outwards from the bottom of the body portion 12, and an arc segment 126 connected between the first expanding segment 124 and the second expanding segment 125. When viewed axially from back to front, the sum of radians of the extension walls 123 on two sides of the body portion 12 in the circumference is greater than or equal to 90°. After many tests, when the ratio of the maximum size of the air inlet 121 in the lateral direction to the maximum size of the body portion 12 in the lateral direction (in the region of the arc segment 126 of the extension wall 123) is greater than or equal to 0.1, when the sum of radians of the circumferences occupied by the air inlet 121 in the circumferential direction perpendicular to the axial direction is greater than or equal to 90°, and when other influencing factors remain unchanged, the blowing efficiency of the blower 100 can satisfy the requirements of most working scenarios in the market.

The receiving wall 122 includes a first side wall 127 facing the handle portion 14 and a second side wall 128 facing the battery pack 50, and in the vertical direction, the mounting portion 13 extends axially backwards from the middle portion of the receiving wall 122, and the first side wall 127 and the second side wall 128 are arranged on two opposite sides of the mounting portion 13, respectively. The second side wall 128 extends in the vertical direction on a bottom side of the mounting portion 13, and is arranged approximately perpendicular to the mounting portion 13. The first side wall 127 extends obliquely forwards and upwards from the top of the mounting portion 13 to the front end of the handle portion 14. The receiving wall 122 further includes a third side wall 129 connected to the second side wall 128, and the first side wall 127 and the third side wall 129 are arranged on two opposite sides of the second side wall 128 in the vertical direction and are arranged approximately symmetrically with respect to the second side wall 128.

The air inlet 121 includes a first air inlet region Z1 parallel to or flush with the first side wall 127, a second air inlet region Z2 parallel to or flush with the second side wall 128, and a third air inlet region Z3 parallel to or flush with the third side wall 129. In the vertical direction, the first air inlet region Z1 and the third air inlet region Z3 are connected to two vertical sides of the second air inlet region Z2. The first air inlet region Z1 is arranged approximately on two sides of the first side wall 127 in the lateral direction, the second air inlet region Z2 is arranged approximately on two sides of the second side wall 128 in the lateral direction, and the third air inlet region Z3 is arranged approximately on two sides of the third side wall 129 in the lateral direction. The included angle formed between the first air inlet region Z1 and the second air inlet region Z2 is greater than or equal to 90°, and the included angle formed between the third air inlet region Z3 and the second air inlet region Z2 is also greater than or equal to 90°.

The blower 100 further includes a number of guiding portions 16 arranged at intervals at the air inlet 121, the guiding portions 16 are spaced apart to avoid outside debris from entering the housing 10 and avoid causing damage to the power assembly 20. In addition, when the guiding portions 16 are spaced apart and the guiding portions 16 have a certain extension length passing through the air inlet 121, the airflow entering the air inlet 121 is guided and combed. Each air inlet region of the air inlet 121 is provided with a plurality of guiding portions 16 which are spaced apart. In the present embodiment, the extension direction of the guiding portion 16 is approximately perpendicular to the overall contour region of the air inlet region, such that an included angle formed between the extension directions of the guiding portions 16 of the adjacent air inlet regions is less than or equal to 90°. Of course, in other embodiments, the extension direction of the guiding portions 16 may also not be perpendicular to the overall contour region of the air inlet region.

The guiding portion 16 and the body portion 12 are integrated, thereby avoiding the need of additionally mounting a wind guiding hood, and avoiding an increase in the mould cost, the material cost and the assembly cost. The extension direction of the guiding portion 16 of the first air inlet region Z1 is approximately perpendicular to the first side wall 127; the extension direction of the guiding portion 16 of the second air inlet region Z2 in the axial direction is set to be approximately parallel to the insertion and extraction direction of the battery pack 50, and the insertion and extraction direction of the battery pack 50 is approximately perpendicular to the second side wall 128; and the extension direction of the guiding portion 16 of the third air inlet region Z3 is approximately perpendicular to the third side wall 129. The included angle formed between the extension directions of the guiding portions 16 of two adjacent air inlet regions is less than or equal to 90°, such that the included angle formed between the flow direction of the airflow entering from the first air inlet region Z1 and the flow direction of the airflow entering from the second air inlet region Z2 is less than or equal to 90°, the included angle formed between the flow direction of the airflow entering from the third air inlet region Z3 and the flow direction of the airflow entering from the second air inlet region Z2 is less than or equal to 90°, and the included angle formed between the airflow entering from the three air inlet regions is smaller, so as to avoid more turbulence generated when multiple airflows in different directions converge, which may lead to influence on and loss of part of the airflow and further increase noise and reducing the efficiency of air inlet.

As shown in combination with FIGS. 3 to 5, the rear end of the air inlet pipe 32 is attached to the inner side of the extension wall 123, and a guiding portion 323 is arranged at the rear end of the air inlet pipe 32, the guiding portion 323 is formed to be a conical ring, i.e., the diameter of the guiding portion 323 is gradually decreased from back to front in the axial direction, such that the airflow of the body portion 12 can be efficiently guided to enter the air inlet pipe 32 before passing through the power assembly 20. The air inlet 121 is spaced apart from the guiding portion 323 by a length of the extension wall 123 in the axial direction, such that the airflow can have a longer distance to tend to the axial airflow after entering the body portion 12, thereby avoiding formation of excessive vortex which may hit against the inner side of the body portion 12 and increase noise, and at the same time improving the efficiency of air inlet.

The mounting portion 13 extends axially backwards from the top end of the second side wall 128 and forms a guiding track 131 on its lower surface for guiding mounting or dismounting of the battery pack 50. The second side wall 128 is provided with an ejection structure 40 for the battery pack 50, and the ejection structure 40 includes a rotating rod 41 rotatably fixed to the second side wall 128 and an elastic member 42 telescopically fixed in the second side wall 128. The tail end of the rotating rod 41 is provided with a protruding block 43 protruding from the second side wall 128, and the elastic member 42 presses against the rotating rod 41, such that the protruding block 43 always has a tendency force protruding out of the second side wall 128, and when the battery pack 50 is unlocked, the protruding block 43 presses against the battery pack 50 to eject the mounting portion 13 in an axial direction.

The supporting portion 15 includes a front portion 151 connected to the front end of the body portion 12 in the axial direction, a rear portion 152 connected to the bottom end of the third side wall 129, and an intermediate portion 153 connecting the front portion 151 to the rear portion 152. The intermediate portion 153 is provided with an intermediate groove 154, and the extension wall 123 of the body portion 12 is provided with a plurality of spaced air inlet holes at the position corresponding to the intermediate groove 154. The rear portion 152 is provided with a notch 155, and the body portion 12 is similarly provided with a number of spaced air inlet holes at the position corresponding to the notch 155. By arranging several spaced air inlet holes at the bottom and the rear portion 152 of the body portion 12, the air inlet region is enlarged and the air blowing efficiency is improved. The third air inlet region Z3 of the air inlet 121 is located approximately on both sides of the notch 155 of the rear portion 152 in the lateral direction.

In the present embodiment, the extension wall 123 of the body portion 12 is approximately a closed structure in the circumferential direction perpendicular to the axial direction, and the receiving wall 122 is also approximately a closed structure in the axial direction, herein the term “approximately a closed structure” means that the top is completely closed, that is, no fluid communication with the outside world exists, or a small number of openings can be formed therein to achieve communication of small airflow inside and outside the housing 10.

In the above embodiment, the battery pack 50 is axially mounted on the rear side of the second side wall 128 of the receiving wall 122, while in other embodiments, the mounting portion 13 may also be arranged to extend from the first side wall 127 of the receiving wall 122 towards the exterior of the housing 10 or the interior of the housing 10, such that the battery pack 50 is at least partially overlapped with the body portion 12 in the vertical direction, and the remaining structure remains unchanged, i.e., the air inlets 121 are still arranged on two sides of the mounting portion 13 in the lateral direction, and through such a setting, the axial size of the whole machine can be further reduced under a premise of ensuring the air inlet efficiency and cost. Among them, the insertion and extraction direction of the battery pack 50 may be along a vertical direction or an inclined direction intersecting with the axial direction.

In the present disclosure, an air inlet 121 connected to the external fluid is arranged at the rear end of the body portion 12 in the axial direction, and the air inlet 121 is laterally located at two sides of the mounting portion 13 for mounting the battery pack 50, such that at least a portion of the airflow flows through the surface of the battery pack 50 before entering the air inlet 121, thereby dissipating heat from the battery pack 50 during operation of the blower 100; in addition, in the present disclosure, an air inlet 121 is arranged on the first side wall 127, the second side wall 128 and the third side wall 129 on the rear end of the body portion 12 in the axial direction, so as to increase the air inlet area; and the included angle formed between the first side wall 127 and the second side wall 128 is greater than or equal to 90°, and the included angle formed between the third side wall 129 and the second side wall 128 is also greater than or equal to 90°. Under guidance of the airflow by the guiding portion 16, the included angle formed between the flow direction of airflow entering from the first air inlet region Z1 and the flow direction of the airflow entering from the second air inlet region Z2 is less than or equal to 90°, and the included angle formed between the flow direction of airflow entering from the third air inlet region Z3 and the flow direction of the airflow entering from the second air inlet region Z2 is less than or equal to 90°, so as to reduce loss caused by collision when the airflow entering from different flow directions converges, and further improve the efficiency of air inlet.

FIGS. 6 to 8 disclose another embodiment of the blower of the present disclosure. The blower includes a housing 10′ extending in an axial direction, an air duct assembly detachably connected to the housing (refer to FIG. 1), a power assembly 20′ at least partially accommodated in the housing, and a battery pack 50 (not shown in the figures) providing energy.

The housing 10′ includes a connecting portion 11′ connected to the air duct assembly at a front end in the axial direction, a body portion 12′ connected to an axial rear side of the connecting portion 11′ in the axial direction, and a mounting portion 13′ configured to connect the battery pack 50 and connected to the body portion 12′, and the battery pack 50 is detachably connected to the mounting portion 13′ in the axial direction. In the axial direction, the connecting portion 11′, the body portion 12′ and the mounting portion 13′ are arranged in sequence. The housing 10′ includes a handle portion 14′ connected at one end to the top of the body portion 12′ and at the other end to the top of the mounting portion 13′, and the handle portion 14′ extends upwards and is spaced apart from the body portion 12′ and the mounting portion 13′ by a certain space, so as to form a gripping space therebetween for a user to hold.

The air duct assembly includes a blowpipe detachably connected to the connecting portion 11′ (refer to FIG. 1), an air inlet pipe 32′ at least partially accommodated in the housing 10′ and a guiding hood 33′ located at the rear end of the air inlet pipe 32′ in the axial direction. The blowpipe, the air inlet pipe 32′ and the guiding hood 33′ together form a channel for the passage of airflow. The air inlet pipe 32′ includes a shell 321′ fixed to the interior of the housing 10′, and the power assembly 20′ is at least partially accommodated in the shell 321′. The power assembly 20′ includes a motor 21′ having a drive shaft 211′ and a fan 22′ driven to rotate by the motor 21′, and the fan 22′ rotates to generate airflow passing through the channel of the air duct assembly.

An air inlet 121′ connected to external fluid is arranged at a rear end of the body portion 12′ in the axial direction, and the blowpipe includes an air outlet located at the front end (refer to FIG. 1) in the axial direction. When the blower 100 operates, the drive shaft 211′ rotates to drive the fan 22′ to rotate and generate a negative pressure in the channel, and the outside air enters the guiding hood 33′ and then enters the channel of the air inlet pipe 32′ from the air inlet 121′ under the action of air pressure, and then the outside air is accelerated by the rotating fan 22′ and is blown out via the air outlet. In the axial direction, the blowpipe, the air inlet pipe 32′, the guiding hood 33′ and the mounting portion 13′ are arranged approximately aligned, such that the airflow does not change the flow direction approximately after entering the housing 10′, and the airflow flows at least partially through the battery pack 50 to cool the battery pack 50 before entering the housing 10′.

The guiding hood 33′ is located between the air inlet pipe 32′ and the air inlet 121′ in an axial direction. The guiding hood 33′ includes an axial opening 331′ located at a rear end in the axial direction, an axial outlet 332′ located at a front end in the axial direction and opposite to the axial opening 331′, and a hood portion 333′ connecting the axial opening 331′ and the axial outlet 332′, the axial opening 331′ corresponds to the air inlet 121′, and the axial outlet 332′ corresponds to the air outlet. In the present embodiment, the hood portion 333′ is approximately a closed structure in a circumferential direction perpendicular to the axial direction.

The projection of the guiding hood 32′ in the vertical direction at least partially overlaps with the projection of the handle portion 14′ in the vertical direction, and the projection of the guiding hood 32′ in the axial direction at least partially overlaps with the projection of the mounting portion 13′ in the axial direction, such that when a user holds the handle portion 14′ for operating the blower, the airflow does not approximately change the flow direction inside the air duct assembly, thereby avoiding loss and improving the efficiency of air inlet.

A guiding portion 323′ is arranged at a rear end of the air inlet pipe 32′, the guiding portion 323′ is formed to be a conical ring, i.e., the diameter of the guiding portion 323′ is gradually decreased from back to front in the axial direction, such that the airflow of the body portion 12′ can be efficiently guided to enter the air inlet pipe 32′ before passing through the power assembly 20′. A plurality of clamping hooks 324′ extend at intervals from the rear end of the guiding portion 323′ in the axial direction, and each clamping hook 324′ continues to extend rearwards from the rear end of the guiding portion 323′. The clamping hook 324′ includes a base portion 325′ extending rearwards from the rear end of the guiding portion 323′ in the axial direction, a hook portion 326′ extending from the rear end of the base portion 325′ in the axial direction towards the body portion 12′, and a hook portion 326′ extending from the base portion 325′ towards the body portion 12′, and a reinforcing portion 327′ extending from the base portion 325′ towards the inner side of the guiding portion 323′.

The guiding hood 33′ includes a positioning portion 334′ located at the front end thereof in the axial direction, and the positioning portion 334′ is formed to be a rib portion extending from the peripheral wall of the hood portion 333′ towards the body portion 12′, The body portion 12′ is internally provided with a fixing portion 17′ which cooperates with the positioning portion 334′ to fix the guiding hood 33′, and the fixing portion 17′ includes an annular groove 171′ accommodating the rib portion. The rib portion includes several clamping grooves 335′ spaced apart in a circumferential direction, and the hook portion 326′ is clamped into the clamping groove 335′ to fix the guiding hood 33′ and the air inlet pipe 32′.

In the radial direction perpendicular to the axial direction, the hook portion 326′ and the reinforcing portion 327′ are located at two opposite sides of the base portion 325′, respectively; in the axial direction, the hook portion 326′ and the reinforcing portion 327′ are located at the front and rear ends of the base portion 325′, respectively, to enhance the strength of the clamping hook 324′ and avoid the risk of breakage when the clamping hook 324′ is clamped into the clamping groove 335′. Several spaced concave portions 336′ are arranged in a circumferential circle of the positioning portion 334′, to enhance the strength of the mating position between the guiding hood 33′ and the body portion 12′ and the air inlet pipe 32′.

In the present embodiment, the guiding hood 33′ is fixed with the air inlet pipe 32′ by means of the clamping hook 324′ in combination with the clamping groove 335′, while in other embodiments, the guiding hood 33′ is fixed with the air inlet pipe 32′ by means of shape fit between the protruding block and the grooves or by means of rotational fit between the protruding block and the guiding groove, as long as the air inlet pipe 32′ and the guiding hood 33′ can be positioned, which will not be expanded in detail herein.

The body portion 12′ includes a receiving wall 122′ located at a rear end in the axial direction, and the mounting portion 13′ extends rearwards from the receiving wall 122′. The receiving wall 122′ includes a first side wall 127′ and a second side wall 128′ arranged on two sides of the mounting portion 13′ in a vertical direction perpendicular to the axial direction, respectively, and a third side wall 129′ connected at the bottom of the second side wall 128′ in an inclined manner. The first side wall 127′, the second side wall 128′ and the third side wall 129′ are all provided with air inlets 121′, and the first side wall 127′ and the third side wall 129′ are respectively arranged to be inclined with the second side wall 128′ to enable the airflow entering the body portion 12′ to have three different flow directions.

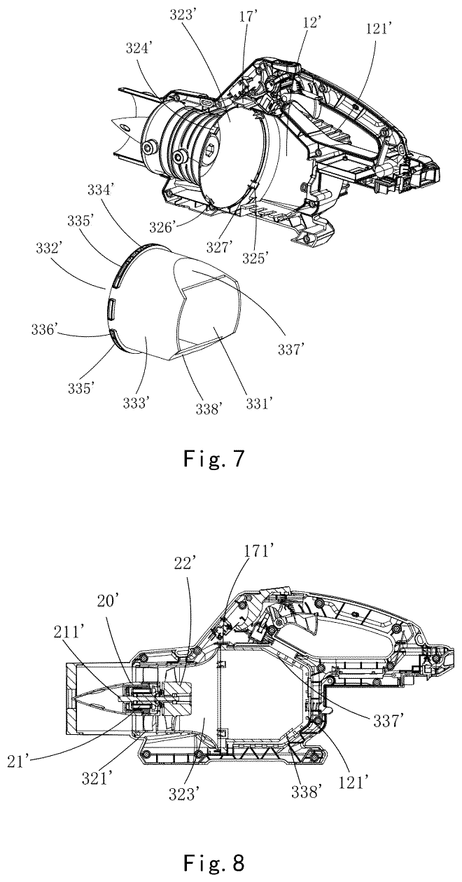

Referring to FIGS. 7 and 8, the guiding hood 33′ is provided with a first inclined guiding portion 337′ corresponding to the first side wall 127′ and a second inclined guiding portion 338′ corresponding to the third side wall 129′. In the lateral direction, the horizontal size of the first inclined guiding portion 337′ is greater than the horizontal size of the first side wall 127′, and the two sides of the first inclined guiding portion 337′ protruding out of the first side wall 127′ correspond to the air inlets 121′ on two sides of the first side wall 127′ in the lateral direction; the horizontal size of the second inclined guiding portion 338′ is greater than the horizontal size of the third side wall 129′, and the two sides of the second inclined guiding portion 338′ protruding out of two sides of the third side wall 129′ correspond to the air inlets 121′ on two sides of the third side wall 129′ in the lateral direction, and the axial openings 331′ correspond to the air inlets 121′ on two sides of the second side wall 128′ in the lateral direction. In the vertical direction, the axial opening 331′ is arranged between the first inclined guiding portion 337′ and the second inclined guiding portion 338′.

A gap is arranged between the first inclined guiding portion 337′ and the first side wall 127′, and after the airflow entering from the air inlets 121′ on two sides of the first side wall 127′ in the lateral direction enters the gap, the airflow enters the guiding hood 33′ from the axial opening 331′ under the guidance of the first inclined guiding portion 337′; a gap is arranged between the second inclined guiding portion 338′ and the third side wall 129′, after the airflow entering from the air inlets 121′ on two sides of the third side wall 129′ in the lateral direction enters the gap, the airflow enters the guiding hood 33′ from the axial opening 331′ under the guidance of the second inclined guiding portion 338′; and a gap is also arranged between the hood portion 333′ and the body portion 12′, in order to increase the air inlet area, an air inlet hole is arranged at the bottom of the body portion 12′, and after the airflow entering from the air inlet hole enters the gap, the airflow flows backwards under the guidance of the outer wall of the hood portion 333′, and enters the axial opening 331′ under the guidance of the second inclined guiding portion 338′, so as to converge with the airflow entering from the air inlet 121′.

The axially extending length of the first inclined guiding portion 337′ is less than the axially extending length of the first side wall 127′, and the axially extending length of the second inclined guiding portion 338′ is less than the axially extending length of the third side wall 129′, such that open windows are arranged at rear ends of the first inclined guiding portion 337′ and the second inclined guiding portion 338′ in the axial direction, and the airflow entering from the first side wall 127′ and the third side wall 129′ enters the interior of the guiding hood 33′ through the open windows.

The first inclined guiding portion 337′ is formed as a truncated surface extending backwards and downwards from the top of the hood portion 333′, and the second inclined guiding portion 338′ is formed as a truncated surface extending backwards and upwards from the bottom of the hood portion 333′. The first inclined guiding portion 337′ is arranged to be parallel to the first side wall 127′, and the second inclined guiding portion 338′ is arranged to be parallel to the third side wall 129′, and such a setting can avoid loss caused by collision when the airflow from different directions converges and can avoid affecting the efficiency of air inlet.

The inner wall of the hood portion 333′ is set to be a smooth curved surface, and the guiding hood 33′ is located between the air inlet 121′ and the air inlet pipe 32′ in an axial direction. The airflow can have a certain length of buffer region after entering the air inlet 121′, such that the airflow passing through the fan 22′ tends to be the axial airflow, thereby avoiding increasing noise or increasing airflow loss caused by a vortex formed when the fan 22′ is hit.

In addition, in order to reduce noise, a noise-reduction region may also be arranged in the interior of the hood portion 333′, and a circle of noise-reduction sponges can be fixed on the inner wall of the hood portion 333′ or a plurality of acoustic-absorbing air holes can be directly arranged on the inner wall of the hood portion 333′, which will not be elaborated in detail herein.

Other structures are the same as those in the first embodiment and will not be described in detail herein.

In the present disclosure, by setting the air inlet 121′ between the air inlet pipe 32′ and the axial direction of the mounting portion 13′, and by arranging a guiding hood 33′ in the body portion 12′ between the air inlet pipe 32′ and the air inlet 121′, the airflow basically flows in the axial direction, thereby avoiding loss and improving the efficiency of air inlet; furthermore, if no guiding hood 33′ is mounted inside the body portion 12′, since a plurality of concave and convex structures are arranged inside the body portion 12′, the plurality of concave and convex structures will block part of the airflow after the airflow enters, thereby leading to airflow loss and generating larger noise, while in the present disclosure, through arranging a guiding hood 33′ in the body portion 12′, the inner wall of the guiding hood 33′ is formed as a smooth curved surface, thereby effectively avoiding the airflow loss and reducing noise at the same time.

The present disclosure is not limited to the specific embodiments described above. Those skilled in the art can easily understand that there are also many alternatives to the blower of the present disclosure without departing from the principles and scope of the present disclosure. The protection scope of the present disclosure is subject to the contents of the claims.

1. A blower, comprising:
a housing extending in an axial direction;
a battery pack detachably connected to the housing;
a power assembly at least partially accommodated in the housing; and
an air duct assembly connected to the housing;
wherein the housing comprises a connecting portion arranged at a front end of the housing in the axial direction and connected to the air duct assembly, a mounting portion arranged at a rear end of the housing in the axial direction and connected to the battery pack, and a body portion arranged between the connecting portion and the mounting portion, the power assembly comprises a motor at least partially arranged in the body portion and a fan driven to rotate by the motor, and the fan is configured to rotate to generate an airflow passing through an interior of the air duct assembly;
the body portion defines an air inlet located at a rear end of the body portion in the axial direction, and the air inlet is approximately located on two opposite sides of the mounting portion in a lateral direction perpendicular to the axial direction.

2. The blower according to claim 1, wherein the airflow enters the housing from the air inlet and flows in a flow direction, the battery pack is at least partially exposed to an upstream of the airflow into the air inlet.

3. The blower according to claim 1, wherein the body portion comprises a receiving wall connected to the mounting portion, the air inlet is approximately parallel to or aligned with the receiving wall in the lateral direction, and the air inlet is approximately located on two sides of the receiving wall in the lateral direction.

4. The blower according to claim 3, wherein the housing comprises a handle portion connected on the body portion and the mounting portion, the receiving wall is approximately a closed structure in the axial direction and comprises a first side wall facing the handle portion and a second side wall facing the battery pack, and the first side wall and the second side wall are respectively located on two opposite sides of the mounting portion in a vertical direction perpendicular to the axial direction and the lateral direction.

5. The blower according to claim 4, wherein the air inlet comprises a first air inlet region located on two sides of the first side wall in the lateral direction and a second air inlet region located on two sides of the second side wall in the lateral direction, and an included angle formed between the flow direction of the airflow entering from the first air inlet region and the flow direction of the airflow entering from the second air inlet region is less than or equal to 90°.

6. The blower according to claim 5, wherein the receiving wall comprises a third side wall connected to the second side wall, the first side wall and the third side wall are located on two respective sides of the second side wall in the vertical direction, the air inlet comprises a third air inlet region located on two sides of the third side wall in the lateral direction, and an included angle formed between the flow direction of the airflow entering from the third air inlet region and the flow direction of the airflow entering from the second air inlet region is less than or equal to 90°.

7. The blower according to claim 1, wherein the blower comprises a number of guiding portions arranged at intervals at the air inlet, the air inlet comprises at least two air inlet regions open towards different directions, an included angle formed between the extension directions of the guiding portions of two adjacent air inlet regions is less than or equal to 90°, and the guiding portion and the body portion are integrated.

8. The blower according to claim 1, wherein the body portion is approximately a closed structure in a circumferential direction perpendicular to the axial direction.

9. A blower, comprising:
a housing extending in an axial direction;
a battery pack detachably connected to the housing;
a power assembly at least partially accommodated in the housing; and
an air duct assembly connected to the housing;
wherein the housing comprises a connecting portion connected to the air duct assembly, a body portion connected to a rear side of the connecting portion in the axial direction, and a mounting portion configured to connect the battery pack and connected to the body portion, the power assembly comprises a motor at least partially arranged in the body portion and a fan driven to rotate by the motor, and the fan is configured to rotate to generate airflow passing through an interior of the air duct assembly;
the body portion defines an air inlet located at a rear end of the body portion in the axial direction, and the air inlet is approximately located on two opposite sides of the mounting portion in a lateral direction perpendicular to the axial direction.

10. The blower according to claim 9, wherein a sum of circumferential radians occupied by the air inlet in the housing in a circumferential direction perpendicular to the axial direction is greater than or equal to 90°.

11. The blower according to claim 1, wherein a sum of circumferential radians occupied by the air inlet in the housing in a circumferential direction perpendicular to the axial direction is greater than or equal to 90°.

12. The blower according to claim 4, further comprising an ejection structure, wherein the ejection structure comprises a rotating rod rotatably fixed to the second side wall, an elastic member telescopically fixed in the second side wall, and a protruding block connected to an end of the rotating rod and protruding from the second side wall, the elastic member presses against the rotating rod such that the protruding block is pushed by a tendency force to protrude out of the second side wall.

13. The blower according to claim 9, wherein the airflow enters the housing from the air inlet and flows in a flow direction, the battery pack is at least partially exposed to an upstream of the airflow into the air inlet.

14. The blower according to claim 9, wherein the body portion comprises a receiving wall connected to the mounting portion, the air inlet is approximately parallel to or aligned with the receiving wall in the axial direction, and the air inlet is approximately located on two sides of the receiving wall in the lateral direction.

15. The blower according to claim 14, wherein the housing comprises a handle portion connecting the body portion to the mounting portion, the receiving wall is approximately a closed structure in the axial direction and comprises a first side wall facing the handle portion and a second side wall facing the battery pack, and the first side wall and the second side wall are respectively located on two opposite sides of the mounting portion in a vertical direction perpendicular to the axial direction and the lateral direction.

16. The blower according to claim 15, wherein the air inlet comprises a first air inlet region located on two sides of the first side wall in the lateral direction and a second air inlet region located on two sides of the second side wall in the lateral direction, and an included angle formed between the flow direction of the airflow entering from the first air inlet region and the flow direction of the airflow entering from the second air inlet region is less than or equal to 90°.

17. The blower according to claim 16, wherein the receiving wall comprises a third side wall connected to the second side wall, the first side wall and the third side wall are located on two respective sides of the second side wall in the vertical direction, the air inlet comprises a third air inlet region located on two sides of the third side wall in the lateral direction, and an included angle formed between the flow direction of the airflow entering from the third air inlet region and the flow direction of the airflow entering from the second air inlet region is less than or equal to 90°.

18. The blower according to claim 15, further comprising an ejection structure, wherein the ejection structure comprises a rotating rod rotatably fixed to the second side wall, an elastic member telescopically fixed in the second side wall, and a protruding block connected to an end of the rotating rod and protruding from the second side wall, the elastic member presses against the rotating rod such that the protruding block is pushed by a tendency force to protrude out of the second side wall.

19. The blower according to claim 9, wherein the blower comprises a number of guiding portions arranged at intervals at the air inlet, the air inlet comprises at least two air inlet regions open towards different directions, an included angle formed between the extension directions of the guiding portions of two adjacent air inlet regions is less than or equal to 90°, and the guiding portion and the body portion are integrated.

20. A blower, comprising:
a housing extending in an axial direction;
a battery pack detachably connected to the housing; and
a power assembly at least partially accommodated in the housing;
wherein the housing comprises a connecting portion arranged at a front end of the housing in the axial direction, a mounting portion arranged at a rear end of the housing in the axial direction and connected to the battery pack, and a body portion arranged between the connecting portion and the mounting portion, the power assembly comprises a motor at least partially arranged in the body portion and a fan driven to rotate by the motor, and the fan is configured to rotate to generate an airflow passing through the body portion;
wherein a width of the body portion is greater than a width of the mounting portion in a lateral direction perpendicular to the axial direction, and the body portion defines a plurality of air inlets approximately located on two opposite sides of the mounting portion in the lateral direction.
